(19) United States
(12) Patent Application Publication
(10) Pub. No.: US 2026/0228673 A1
(43) Pub. Date: Aug. 6, 2026

(54) DYNAMIC ANOMALY DETECTION FOR REDUCED PERISHABLE ITEM WASTAGE

(71) Applicant: Walmart Apollo, LLC, Bentonville, AR (US)

(72) Inventors: Abhishek Ghosh, Bangalore (IN); Vamshi Vadla, Bangalore (IN); Ashish Goyal, Rajasthan (IN); Tejas Dokras, Bengaluru (IN); Sunny Kumar, MuzaffarNagar (IN); Avinash M. Jade, Bangalore (IN); Ivan Kanev, San Francisco, CA (US)

(21) Appl. No.: 19/042,744

(22) Filed: Jan. 31, 2025

(51) Int. Cl. G06Q 10/0832

(52) U.S. Cl. CPC G06Q 10/0832

(57) ABSTRACT

Examples provide a system and method for predicting future wastage of perishable goods received at a distribution center based on shelf life of each type of perishable item and age of arrival (AoA) when received. The system implements a ML model to predict the wastage for a given item or batch of items based on item-specific data, supplier data, transit data, etc. The system estimates quantity of throws at a DC level and/or a store level to reduce future wastage and ensure quality of perishable items received at the DC and stores. The system generates anomalous shipment alerts after quality control inspections at user-configurable intervals enabling users to take action to mitigate wastage. The predictions are used to determine whether to recommend rejection of a shipment and return to a supplier or acceptance of the shipment with possible additional actions to mitigate the predicted future wastage.

### BACKGROUND

Perishable items, such as fresh produce, have a limited shelf life on arrival at a destination, such as a store or order distribution center. Perishable items sometimes arrive at the destination with insufficient remaining shelf life to enable sale or delivery of the items to customers or it leads to sales of suboptimal quality. This results in increased wastages associated with disposal of items that have reached the end of their shelf life and potentially increased club wastage and increased customer returns of items which may be nearing the end of their shelf life. Current systems typically do not enable merchants to accurately and efficiently determine the suboptimal quality and possible downwards wastage at the time of inspection at distribution center (DC) due to difficulties associated with accurately tracking items in club. This can result in increased costs associated with perishable item throws as well as uncertain inventory levels for perishable items and potential increases in overall customer dissatisfaction.

### SUMMARY

Some examples provide a system and method for anomaly detection mitigating perishable item wastage. Item-specific data associated with a plurality of perishable items received at a distribution center (DC) and historical quality-related data associated with previous batches of perishable items received at the DC is obtained. A machine learning (ML) model detects an anomalous batch of perishable items within the plurality of perishable items based on analysis of the item-specific data and the historical quality-related data. The ML model is trained to detect anomalies on the basis of age on arrival (AoA) or remaining shelf life in the item-specific data. Age-related data associated with the detected anomalous batch of perishable items is calculated. The age-related data includes a calculated age on arrival (AoA) and an estimated remaining shelf life. A future impact of the anomalous batch of perishable items is estimated using the calculated age-related data and an item-specific dynamic threshold, wherein the estimated future impact comprises an estimated quantity of throws due to wastage. For example, the total impact will be the expected wasted units from a item in a Purchasing Order (PO) multiplied by the average selling price of a unit in that PO. A recommendation to accept or reject the anomalous batch of perishable items is generated based on the estimated future impact. The recommendation including a recommended action to mitigate perishable item wastage. The generated recommendation is surfaced via a user interface (UI) device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a system for threshold-based anomaly detection to predict future wastage.

FIG. 2 is an exemplary block diagram illustrating an environment for anomaly detection.

FIG. 3 is an exemplary block diagram illustrating a detection component for perishable item anomaly detection.

FIG. 4 is an exemplary flow chart illustrating operation of the computing device to estimate future impact of anomalous shipments of perishable items.

FIG. 5 is an exemplary flow chart illustrating operation of the computing device to generate a recommendation to accept or reject an anomalous shipment of perishable items based on predicted future impact on wastage.

FIG. 6 is an exemplary graph illustrating anomaly detection of age on arrival at a DC.

FIG. 7 is an exemplary graph illustrating soft and hard thresholds for use in detecting anomalies associated with shipments of perishable items.

FIG. 8 is an exemplary graph illustrating an impact model for age on arrival direction of threshold.

FIG. 9 is an exemplary graph illustrating an impact model for sell-by-date direction of threshold.

FIG. 10 is an exemplary diagram illustrating an email alert associated with an anomalous batch of perishable items.

FIG. 11 is an exemplary diagram illustrating an alerts dashboard showing alert-related data for a plurality of alerts associated with a plurality of perishable item orders.

Corresponding reference characters indicate corresponding parts throughout the drawings.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some examples, . . . ” For brevity and clarity of presentation, this implied leading clause is not repeated ad nauseum.

In our scenario of supply chain, after delivery of fresh produce or other perishable items to Distribution Centers (DCs) by suppliers, a quality control team inspects the items by sampling them. Depending on the results, some items are accepted and stored in the DCs to be sent out to stores in the future. Some are rejected and sent back to the suppliers, while others are accepted. The items categorized as acceptable are stored in the DCs for a couple of days. Before they are dispatched to the stores, they are inspected again, and some items that don't pass the inspection contribute to DC wastage or pulls. Generally, it takes one day for the items to reach the corresponding stores, where they are shelved for sale. Every day, stores experiences wastage due to the perishability of the produce. Thus, it is typically desirable to filter out and keep only fresh items at the DCs and remove the rest to reduce the significant amount of wastage, referred to as store throws. It is typically undesirable to sell items approaching expiry due to high age-on-arrival may lead to customer dissatisfaction.

Filtering out the fresher items manually during inspection is not possible because it depends on the item's age range, distance from the harvest area to the DC, time of the year and several other factors.

Perishable items being transported from a supplier or other source, such as a distribution center (DC) to various stores or other destinations can have varying lengths of residence at the DC prior to shipment, varying transit times from the DC to the store, and varying age upon arrival. Perishable items can include any type of item having a limited shelf life, such as, but not limited to, produce, bread, meat, etc. Produce can include fruits, vegetables, berries, melons, or any other type of produce. Different types of perishable items have differing shelf-life spans. For example, oranges and apples can have a longer shelf life than strawberries and raspberries. Therefore, it is important to identify remaining shelf life for items upon arrival at a store, order fulfillment center, or other destination. However, there is no consistent quantization, such as residence times and transit times between the DC-to-store. This makes it challenging to accurately track wastages based on age of the items upon arrival or remaining shelf life of perishable items. Lack of purchase order (PO) information at stores further complicates assessment of wastages of fresh items making it more difficult to correlate product age and item wastage.

With numerous suppliers from different parts of the world delivering perishable Items to various DCs, it's nearly impossible to manually consider all features impacting quality during inspections. Suppliers delivering from nearby locations generally provide produce of lower age upon arrival, or with a higher remaining shelf life. Conversely, suppliers delivering from further areas tend to provide produce of higher age upon arrival, or with a lower remaining shelf life. To summarize, a particular value of age upon arrival for an item could be considered normal at a DC for one supplier, but the same value could be anomalous for the same item at the same DC for a different supplier at a similar time of year. Therefore, the embodiments recognize a need for an automated system or model to detect anomalies based on these features right after inspections at DCs.

In the current situation, DCs are sending all fresh produce, irrespective of their age upon arrival or remaining shelf life, to the corresponding stores or other destinations. As a result, perishable items may have remaining shelf life that is less than desired when they reach the stores. Moreover, they have a comparatively shorter time to be sold to customers. Resulting In higher levels of wastage.

Referring to the figures, examples of the disclosure enable threshold-based anomaly detection using a trained machine learning (ML) model. In some examples, anomalous batches of perishable items are detected using age-related item-specific data, such as, calculated age on arrival (AoA) and estimated remaining shelf life (RSL).

Aspects of the disclosure further enable prediction of future impact of anomalous batches of perishable items received at a DC. The computing device operates in an unconventional manner by finding anomalous Purchasing Orders (PO) using age-related item specific data. The system then calculates predicted wastage at various levels, such as at the DC level and the store level to estimate quantity of perishable items from each shipment or order that is likely to result in unsellable product, which is referred to as wastage. The predicted amounts of wastage for each order or batch of perishable items are used to determine whether the order or batch of perishable items should be accepted or rejected at the DC. In this manner, the system is able to anticipate and prevent future wastage at all levels to reduce overall costs, improve replenishment of perishable items, and improve fulfillment of perishable items to customers. The system provides alerts notifying users of the detected anomalies, predicted amounts of wastage for each batch of perishable items, and recommended course of action to mitigate the predicted amount of wastage. This enables improved user efficiency via UI interaction, increased user interaction performance, actionability by the quality control team, and reduced error rate in order replenishment and order fulfillment.

Other embodiments provide alerts, including recommendations associated with anomalous batches of perishable Items. These alerts optionally Include recommended actions to reduce wastage, such as expediting shipment of anomalous batches of Items to stores or other destinations to ensure these Items have a sufficient shelf life remaining upon arrival at the stores. Thus, the alerts, Including recommended actions, help DCs prioritize shipments to stores, negotiate with suppliers more effectively in the future, and significantly reduce waste at both the DC and store levels.

Anomaly Detection can play an important role in supply chain management. However, when it comes to time series data, the process becomes a bit tricky and demands a special technique. In some embodiments, the system enables detection of anomalies based on past behavior with the help of machine learning methods. This detection allows for the generation of alerts to notify relevant stakeholders, helping to avert any potential situations that might lead to financial loss.

In some embodiments, the system provides a machine learning-driven, dynamic threshold-based model trained to detect anomalies associated wth perishable items received at the DC. The ML model helps the DCs take action on anomalous batches (orders) which have a higher age on arrival or shorter remaining shelf life, thus reducing wastage down the line. This model enables the DCs to identify the anomalous batches of perishable items right after quality control inspection, saving substantially on inventory charges, handling fees, logistics costs, etc. Additionally, customer complaints would be decreased by a significant margin.

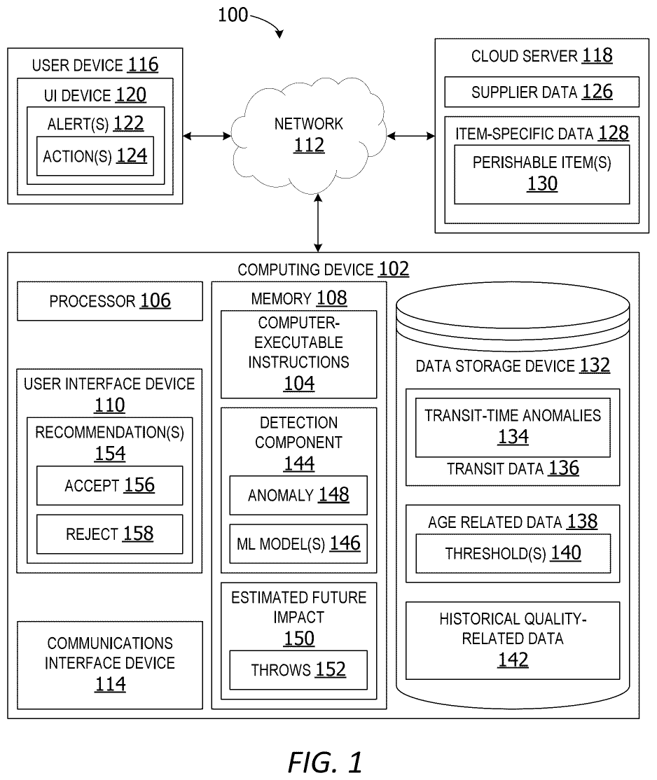

Referring again to FIG. 1, an exemplary block diagram illustrates a system 100 for threshold-based anomaly detection to predict future wastage. In the example of FIG. 1, the computing device 102 represents any device executing computer-executable instructions 104 (e.g., as application programs, operating system functionality, or both) to implement the operations and functionality associated with the computing device 102. The computing device 102, in some examples includes a mobile computing device or any other portable device. A mobile computing device includes, for example but without limitation, a mobile telephone, laptop, tablet, computing pad, netbook, gaming device, and/or portable media player. The computing device 102 can also include less-portable devices such as servers, desktop personal computers, kiosks, or tabletop devices. Additionally, the computing device 102 can represent a group of processing units or other computing devices.

In some examples, the computing device 102 has at least one processor 106 and a memory 108. The computing device 102, in other examples includes a user interface device 110.

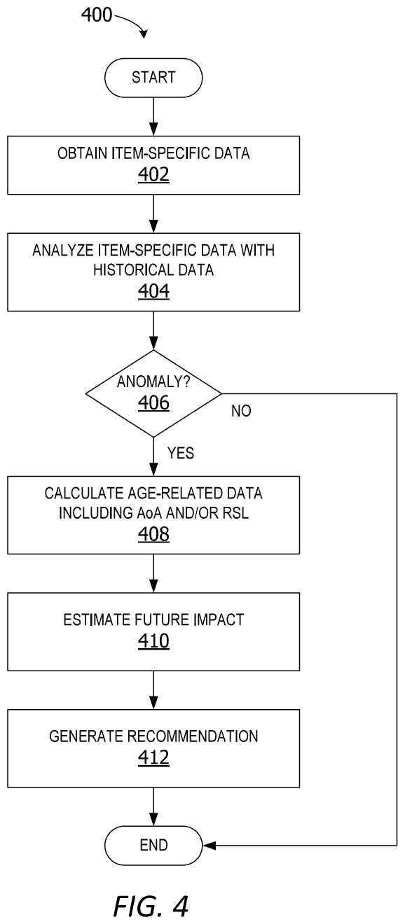

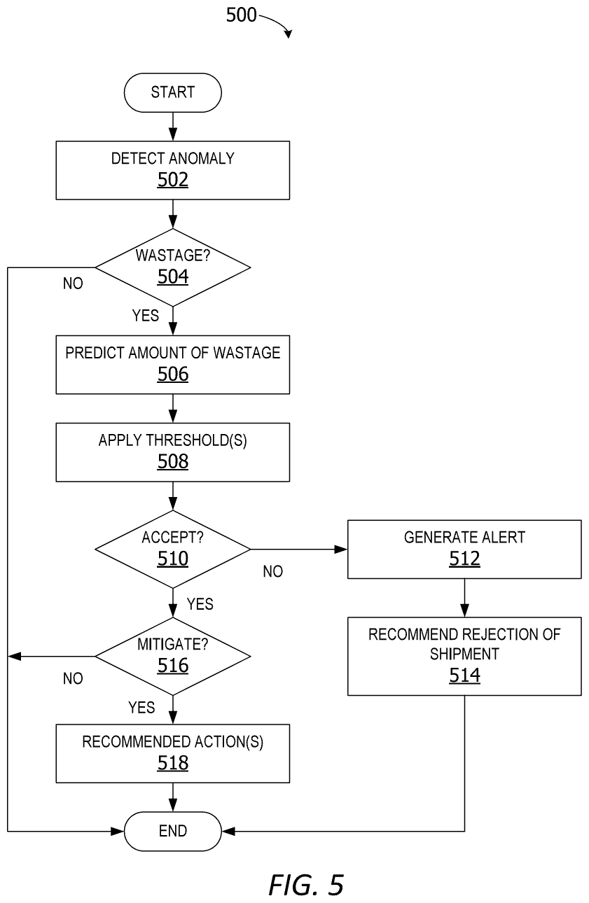

The processor 106 includes any quantity of processing units and is programmed to execute the computer-executable instructions 104. The computer-executable instructions 104 are performed by the processor 106, performed by multiple processors within the computing device 102 or performed by a processor external to the computing device 102. In some examples, the processor 106 is programmed to execute instructions such as those illustrated in the figures (e.g., FIG. 4 and FIG. 5).

The computing device 102 further has one or more computer-readable media such as the memory 108. The memory 108 includes any quantity of media associated with or accessible by the computing device 102. The memory 108 in these examples is internal to the computing device 102 (as shown in FIG. 1). In other examples, the memory 108 is external to the computing device (not shown) or both (not shown). The memory 108 can include read-only memory and/or memory wired into an analog computing device.

The memory 108 stores data, such as one or more applications. The applications, when executed by the processor 106, operate to perform functionality on the computing device 102. The applications can communicate with counterpart applications or services such as web services accessible via a network 112. In an example, the applications represent downloaded client-side applications that correspond to server-side services executing in a cloud.

In other examples, the user interface device 110 includes a graphics card for displaying data to the user and receiving data from the user. The user interface device 110 can also include computer-executable instructions (e.g., a driver) for operating the graphics card. Further, the user interface device 110 can include a display (e.g., a touch screen display or natural user interface) and/or computer-executable instructions (e.g., a driver) for operating the display. The user interface device 110 can also include one or more of the following to provide data to the user or receive data from the user: speakers, a sound card, a camera, a microphone, a vibration motor, one or more accelerometers, a BLUETOOTH® brand communication module, wireless broadband communication (LTE) module, global positioning system (GPS) hardware, and a photoreceptive light sensor. In a non-limiting example, the user inputs commands or manipulates data by moving the computing device 102 in one or more ways.

The network 112 is implemented by one or more physical network components, such as, but without limitation, routers, switches, network interface cards (NICs), and other network devices. The network 112 is any type of network for enabling communications with remote computing devices, such as, but not limited to, a local area network (LAN), a subnet, a wide area network (WAN), a wireless (Wi-Fi) network, or any other type of network. In this example, the network 112 is a WAN, such as the Internet. However, in other examples, the network 112 is a local or private LAN.

In some examples, the system 100 optionally includes a communications interface device 114. The communications interface device 114 includes a network interface card and/or computer-executable instructions (e.g., a driver) for operating the network interface card. Communication between the computing device 102 and other devices, such as but not limited to a user device 116 and/or a cloud server 118, can occur using any protocol or mechanism over any wired or wireless connection. In some examples, the communications interface device 114 is operable with short range communication technologies such as by using near-field communication (NFC) tags.

The user device 116 represents any device executing computer-executable instructions. The user device 116 can be implemented as a mobile computing device, such as, but not limited to, a wearable computing device, a mobile telephone, laptop, tablet, computing pad, netbook, gaming device, and/or any other portable device. The user device 116 includes at least one processor and a memory. The user device 116 can also include a user interface (UI) device 120. In some embodiments, the UI device 120 and/or the user interface device 110 are utilized to surface one or more alert(s) 122 to one or more users. An alert in the one or more alert(s) 122 is an alert associated with a detected anomaly associated with a one or more perishable items received in a shipment at a DC. The alert(s) 122 optionally includes one or more recommended action(s) 124 to be taken to mitigate any predicted future wastage associated with the detected anomaly.

In some embodiments, the system 100 utilizes time series data associated with shipments to detect an anomaly. A time series consists of several components, namely: Trend, Seasonality, and Residuals. Due to these components, it is not straightforward to identify the anomalies. During some seasons, a higher value might be considered as ‘normal’, whereas in other seasons, the same value might seem abnormal. An observation that deviates significantly from the rest of the time series, even when taking seasonality and other components into consideration, should raise suspicions that something might have gone wrong at that point in time. The detection component detects these anomalies and raise alert(s) 122 for relevant users to restore normalcy.

The cloud server 118 is a logical server providing services to the computing device 102 or other clients, such as, but not limited to, the user device 116. The cloud server 118 is hosted and/or delivered via the network 112. In some non-limiting examples, the cloud server 118 is associated with one or more physical servers in one or more data centers. In other examples, the cloud server 118 is associated with a distributed network of servers.

In some embodiments, the cloud server 118 stores data accessible to the computing device and/or the user device via the network 112, such as, but not limited to, supplier data 126 and/or item-specific data 128. Supplier data 126 is data associated with a supplier of perishable items received at the DC. Item-specific data 128 is data associated with one or more perishable item(S) 130 of the same type received at the DC. For example, the perishable item(s) 130 can include a batch of strawberries received in a shipment from a supplier.

The system 100 can optionally include a data storage device 132 for storing data, such as, but not limited to transit data 136, age-related data 138, threshold(s) 140, and/or historical quality-related data 142. The transit data 136 is data associated with transit times for shipping perishable items from a supplier or other source to the DC. The transit data 136 is used by a detection component 144 to detect transit-time anomalies 134 associated with the transit data 136. A transit-time anomaly is an anomaly associated with the amount of time perishable items spend in transit to the DC.

Age-related data 138 includes data associated with the age of perishable item(s) 130, such as the age of an item at arrival to the DC, the remaining shelf life, etc. The threshold(s) 140 include one or more thresholds for use in detecting anomalies and/or determining whether to accept or reject shipments of perishable items. The historical quality-related data 142 in other embodiments includes historical data associated with previous shipments of perishable items received at the DC and/or the wastages of perishable items at various levels.

The data storage device 132 can include one or more different types of data storage devices, such as, for example, one or more rotating disks drives, one or more solid state drives (SSDs), and/or any other type of data storage device. The data storage device 132 in some non-limiting examples includes a redundant array of independent disks (RAID) array. In some non-limiting examples, the data storage device(s) provide a shared data store accessible by two or more hosts in a cluster. For example, the data storage device may include a hard disk, a redundant array of independent disks (RAID), a flash memory drive, a storage area network (SAN), or other data storage device. In other examples, the data storage device 132 includes a database.

The data storage device 132 in this example is included within the computing device 102, attached to the computing device, plugged into the computing device, or otherwise associated with the computing device 102. In other examples, the data storage device 132 includes a remote data storage accessed by the computing device via the network 112, such as a remote data storage device, a data storage in a remote data center, or a cloud storage.

The memory 108 in some examples stores one or more computer-executable components, such as, but not limited to, the detection component 144. The detection component 144, when executed by the processor 106 of the computing device 102, obtains item-specific data 128 associated with a plurality of perishable items received at a DC and historical quality-related data 142 associated with previous batches of perishable items received at the DC. The detection component 144 includes one or more trained machine learning (ML) model(s) 146 analyzes the historical quality-related data 142 and/or item-specific data 128 to detect an anomaly 148 associated with a batch of one or more perishable item(s) 130. The ML model(s) 146 is trained to detect anomalies in the item-specific data, including transit-time anomalies associated with transit delays.

In some embodiments, the detection component 144 calculates age-related data 138 associated with the detected anomalous batch of perishable items. The age-related data 138 includes an calculated age on arrival (AoA) of the perishable item(s) 130 and/or an estimated remaining shelf life of the perishable item(s) 130. The detection component 144 estimates a future impact 150 of the anomalous batch of perishable items using the calculated age-related data and one or more threshold(s) 140, such as, but not limited to an item-specific dynamic threshold. The estimated future impact 150 includes an estimated quantity of throws 152 likely to occur in the future due to wastage of a portion of the perishable items in the anomalous batch of perishable items. The throws 152 refers to perishable items which are unsuitable for sale. Throws 152 include perishable items which may be donated if sufficient shelf life remains available or disposed of if insufficient shelf life remains for consumption.

The detection component 144, in other embodiments, generates one or more recommendation(s) 154 to accept 156 or reject 158 the anomalous batch of perishable items based on the estimated future impact 150. The recommendation optionally includes one or more action(s) 124 to mitigate perishable item wastage. The recommendation(s) 154 are surfaced to a user via a UI, such as, but not limited to, the user interface device 110 and/or the UI device 120.

A recommendation in the recommendations(s) 154 includes a recommendation associated with a single batch or single shipment of perishable items of the same type of item. An alert in the alert(s) 122 can include alerts associated with multiple batches of items of multiple different types received at the DC during a user-specific time-period. An alert can include one or more notifications including one or more recommendations for one or more different batches of items.

In some embodiments, the detection component 144 detects anomalies in time series data using a seasonal hybrid extreme studentized deviate (SH-ESD) method, which comprises of deciding on the value of a hyperparameter. This represents the maximum proportion of data which can be identified as anomalies. Generally, it lies between 0 and 0.499. There cannot be more than 50% of the data identified as anomalies. The system assumes the correct model for the time series, such as additive or multiplicative. Peeling off the different components, such as trends and seasonality, the system utilizes different types of seasonality relevant to the time series. For hourly time series data, the system optionally considers daily, weekly, or yearly seasonality. Then, for detecting the anomaly, the detection component 144 performs a statistical hypothesis testing on the extreme studentized deviate residuals to come up with the k anomalies.

The detection component 144 detects anomalies and establishes the threshold used and delta for better visual representation. This also assists with understanding the criticality of the alert. The critical value is used to derive the delta as a point of reference. The following equation:

$$T = \{ {t}_{1} , {t}_{2} , … , {t}_{n} \}$$

denotes an additive time series with seasonality factor S_t and Trend factor T_t.

$$T = {T}_{t} + {S}_{t} + {R}_{t}$$

Where Rₜ denotes the error term. The system estimates T_t and S_t and removes those from the original time series, let, R₁, R₂, . . . , Rₙ denote the residuals left. ESD computes the following test statistics for the k most extreme observations:

$${C}_{k} = {max}_{k} \vert {R}_{k} - \overline{R} \vert / s$$

where s=bŝ, then

$$\hat{s} = MAD = {median}_{i} \vert {R}_{i} - {median}_{j} ( {R}_{j} ) \vert$$

where B=1/Q(0.75) where Q(0.75) is the 75th percentile of the underlying distribution. Then this test statistic is compared with the critical value l(k), as follows:

$$\frac{( n - k ) {t}_{p , n - k - 1}}{\sqrt{( n - k + 1 ) ( n - k - 1 + {t}_{p , n - k - 1}^{2} )}}$$

As shown above, thresholds are calculated, in some embodiments, with the help of the critical value.

The system primarily generates alerts based on two categories, the age on arrival and the remaining shelf life In days. For some fresh produce, the age on arrival Is calculated at the time of inspection using the harvest date. For other fresh produce, which have a packed date and expiry date, the remaining shelf life is calculated in days.

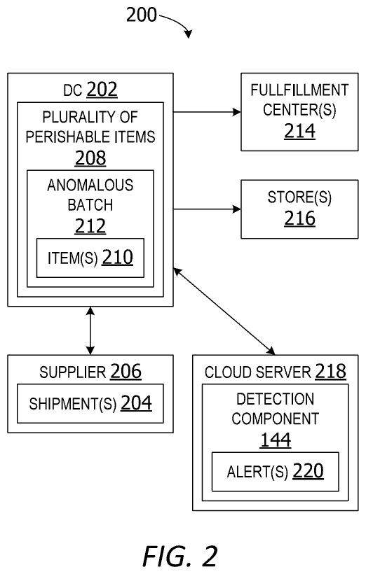

FIG. 2 is an exemplary block diagram illustrating an environment 200 for anomaly detection. The DC 202 receives one or more shipment(s) 204 from a supplier 206. The shipment(s) 204 include a plurality of perishable items 208. A detection component 144 analyzes data associated with the shipment(s) 204 and historical data to detect anomalies associated with one or more item(s) 210 in an anomalous batch 212 of items of the same type. The detection component 144 determines whether to accept the anomalous batch 212 or reject the anomalous batch 212. If the anomalous batch 212 of item(s) 210 is rejected, it can be sent back to the supplier 206. If the anomalous batch 212 of item(s) 210 is accepted, it can be shipped to a destination, such as, but not limited to, one or more fulfillment center(s) 214 and/or one or more store(s) 216.

In this example, the detection component 144 is implemented on a cloud server 218. The cloud server is a server associated with a cloud platform, such as, but not limited to, the cloud server 118 in FIG. 1. The detection component 144 in other embodiments, is implemented on a computing device, such as, but not limited to, the computing device 102 and/or the user device 116 in FIG. 1. The detection component 144 generates one or more alert(s) 220 associated with the detected anomalous batch 212 of item(s) 210. The alert(s) 220 include one or more alerts, such as, but not limited to, the alert(s) 122 in FIG. 1.

In some embodiments, perishable (fresh) items have one of two types of ages: age on arrival (AoA) and remaining shelf life. The detection component 144 detects anomalies and generates alerts on the age on arrival or remaining shelf life (depending on the item) at DC for all fresh produce and other perishable items immediately after they are inspected by the quality control team. This enables the DCs to send only the freshest items to the corresponding stores and/or fulfillment centers, resulting in less waste and fewer complaints from customers. This can reduce approximately 5-10% wastage, which can result in millions of dollars in savings.

In some embodiments, the system attempts to detect orders that remain in a particular status or stage longer than usual. Any order that gets stuck at a particular status or step runs a high risk of delays in subsequent stages and may not be delivered to the customer or other destination within the scheduled time-slot. The system provides alerts for orders that get stuck at any stage longer than usual. However, getting alerted for each order stuck at different stages during the order flow could overwhelm any system and may not necessarily be critical. Therefore, the detection component generates alerts if the hourly number of orders which are not progressing to the next status within the usual time exceeds a certain threshold. These proactive alerts assist users in identifying critical orders at risk of not being delivered within the scheduled time-slot. It enables the system to push these orders to the next stage to ensure successful on-time delivery. In other embodiments, the system generates alerts on the anomalous number of orders stuck at the created, released, or acknowledged state on an hourly basis for each store to prevent any potential delays in customer order pick-up.

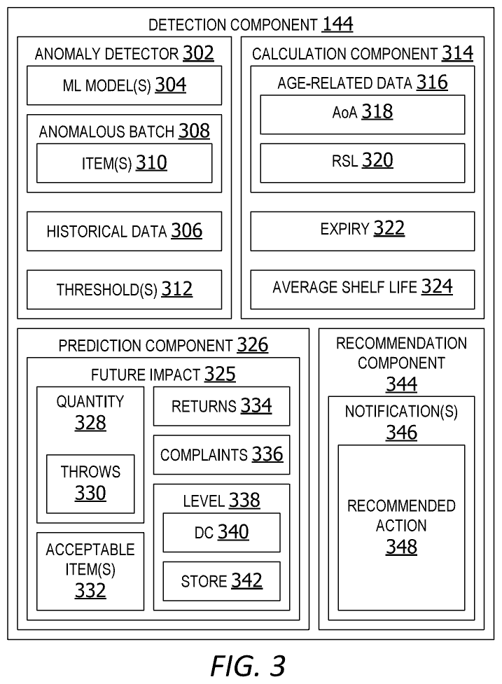

Returning now to FIG. 3, an exemplary block diagram illustrating a detection component 144 for perishable item anomaly detection is shown. In some embodiments, an anomaly detector obtains item-specific data associated with a plurality of perishable items received at a DC and historical data 306 associated with previous batches of perishable items received at the DC. The historical data 306 includes historical quality-related data, such as, but not limited to, the historical quality-related data 142 in FIG. 1. The anomaly detector 302 includes one or more trained ML model(s) 304 for detecting an anomalous batch 308 of item(s) 310 using the historical data 306 and one or more threshold(s) 312.

In other embodiments, a calculation component 314 calculates age-related data 316, including calculated age on arrival (AoA) 318 and/or estimated remaining shelf life (RSL) 320 for the anomalous batch 308 based on item-specific data, such as expiry 322 and/or average shelf life 324 for the item(s) 310 in the anomalous batch 308. A prediction component 326 estimates a future impact 325 of the anomalous batch 308 of perishable items using the calculated age-related data and an item-specific dynamic threshold. The estimated future impact 325 includes an estimated quantity 328 of throws 330 due to wastage. In other embodiments, the future impact 325 includes a predicted number of acceptable item(s) 332, number of returns 334, and/or number of complaints 336. The future impact 325 can be determined at a DC 340 level 338 and/or at a store 342 level.

A recommendation component 344, in some embodiments, generates one or more notification(s) 346 regarding anomalous batches of perishable items and predicted future impact 325 of the anomalies. The notification(s) 346 optionally include a recommended action 348, such as a recommendation to accept a shipment, reject a shipment, re-negotiate with the supplier, accelerate shipment of the item(s) to a recipient, or other action to mitigate the future impact 325. The notification(s) 346 are surfaced to the user via a UI. In this example, a notification in the notification(s) 246 is a notification associated with a single shipment. An alert can include multiple notifications associated with multiple different shipments received at the DC within a given time-period.

FIG. 4 is an exemplary flow chart illustrating operation of the computing device to estimate future impact of anomalous shipments of perishable items. The process 400 shown in FIG. 4 is performed by a detection component, executing on a computing device, such as the computing device 102 or the user device 116 in FIG. 1.

The process begins by obtaining item-specific data at 402. The item-specific data is data associated with perishable items received at a DC, such as, but not limited to, the item-specific data 128 in FIG. 1. The item-specific data is analyzed with historical data at 404. The historical data is data associated with previous shipments of perishable items, such as, but not limited to, the historical quality-related data 142 in FIG. 1 and/or the historical data 306 in FIG. 3. A determination is made whether an anomaly is detected at 406. If yes, age-related data is calculated, including age on arrival and/or remaining shelf life for the perishable items at 408. Future impact of the anomalous batch of items is estimated at 410. A recommendation is generated at 412. The recommendation is a recommendation to accept or reject the batch of perishable items, such as, but not limited to, the recommendation(s) 154 in FIG. 1, the alert(s) 122 in FIG. 1, the alert(s) 220 in FIG. 2, and/or the notification(s) 346 in FIG. 3.

While the operations illustrated in FIG. 4 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 4.

FIG. 5 is an exemplary flow chart illustrating operation of the computing device to generate a recommendation to accept or reject an anomalous shipment of perishable items based on predicted future impact on wastage. The process 500 shown in FIG. 5 is performed by a detection component, executing on a computing device, such as the computing device 102 or the user device 116 in FIG. 1.

The process begins by detecting an anomaly at 502. A determination is made whether future wastage is predicted at 504. The wastage refers to predicted future wastage associated with perishable item throws. If yes, an amount of wastage is predicted at 506. One or more threshold(s) are applied at 508 to determine whether to accept the anomalous batch of items. A determination is made whether to accept at 510. If no, an alert is generated at 512. A recommended rejection of the shipment is generated at 514. The process terminates thereafter.

If a determination is made to accept the shipment at 510, a determination is made whether any action should be taken to mitigate the predicted future wastage associated with the shipment at 516. If yes, one or more recommended action(s) for reducing the number of throws is generated at 518. The process terminates thereafter.

While the operations illustrated in FIG. 5 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 5.

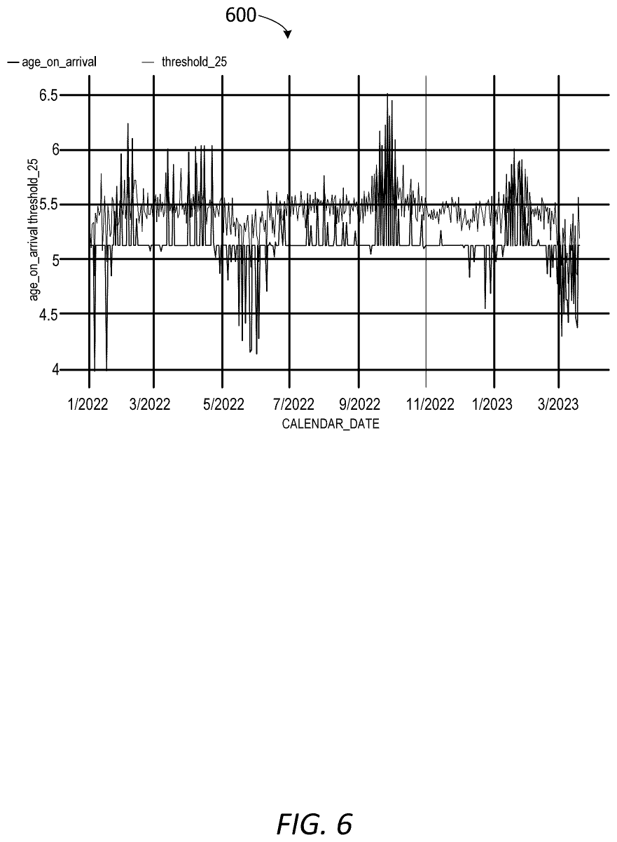

FIG. 6 is an exemplary graph 600 illustrating anomaly detection of age on arrival at a DC. In some embodiments, the system generates alerts twice daily following inspections at each DC for each type of fresh produce and each country they are supplied from. For each alert, the maximum threshold for age-on-arrival produce and the minimum remaining shelf life for sell-by-date produce Is determined. The deviation from these key performance indicators (KPIs) are then calculated. Furthermore, for each anomalous order (batch of items), the potential impact (in terms of throws, defective returns, and complaints per million units) if the produce reaches the stores for sale Is predicted. The graph 600 shows anomaly thresholding at a given DC on daily average age on arrival for all inbound strawberries from all suppliers.

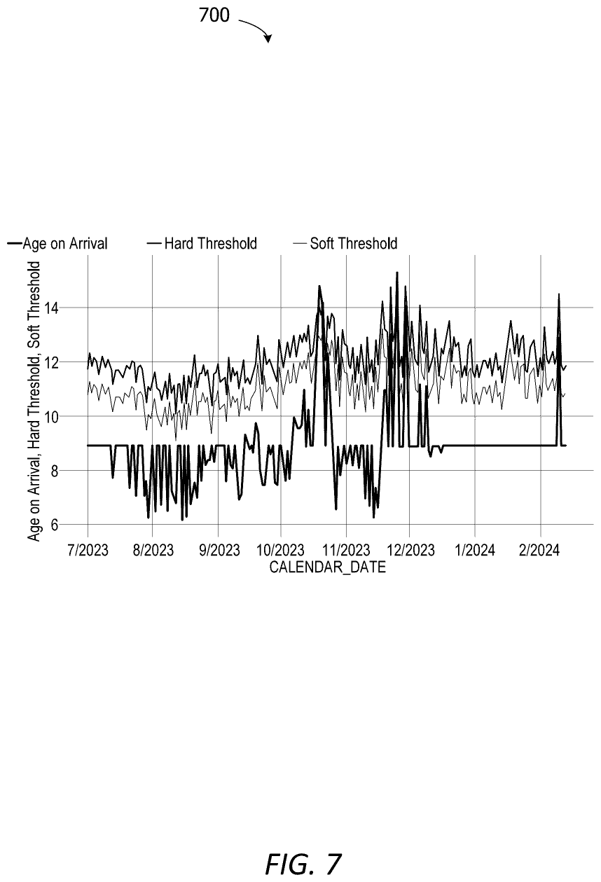

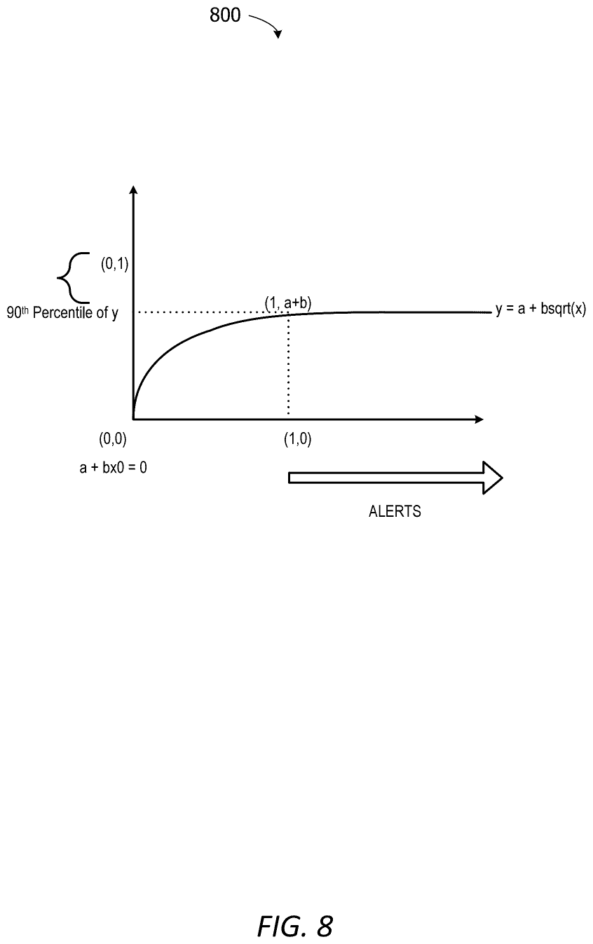

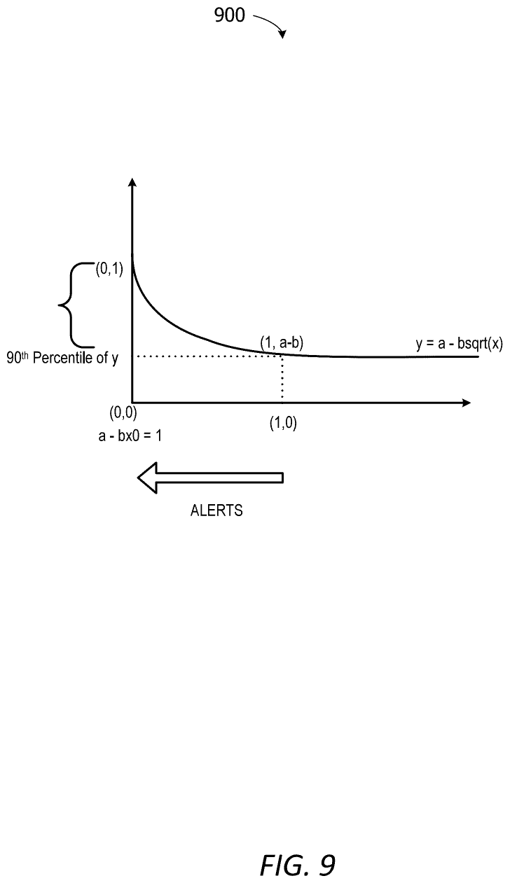

FIG. 7 is an exemplary graph 700 illustrating soft and hard thresholds for use in detecting anomalies associated with shipments of perishable items. Alerts can be adjusted to be either soft or hard by varying a hyperparameter k. The higher the value of k, the harder the threshold. The impact model differs between age on arrival and sell-by-date (SBD) items due to the different directions of their thresholds, as shown in FIG. 8 and FIG. 9 below.

Referring now to FIG. 8, an exemplary graph 800 illustrating an impact model for age on arrival direction of threshold is shown. The independent variable is defined as the age on arrival of a shipment (order) divided by the threshold. The dependent variable, y, is defined as a function of the impacted throws for a particular PO. However, throws at the store level are entangled and attributed by perishable item orders spread over the last few days. Using an ML model, the weightages of perishable item order quantities contributing to the store throws in the next few days are derived. These derived throws are used to calculate the impacted throws from the next few days' absolute throws, which becomes the impacted throws. This is divided by the total accepted quantities for that day for that DC to derive the dependent variable. A mathematical model is fit to y~x. For any anomalous perishable Item orders (batch), the age on arrival divided by the threshold is input into the model and estimate what proportion of the total accepted quantities would be wasted as throws. This value is multiplied by the total accepted quantities to estimate the total impacted throws by that order. The impacted dollar throws Is obtained by multiplying it with the average prices from the past few days at the stores that are mapped with the particular DC. Equations are as follows:

$$a + b * 0 = 0$$

$$a + b * 1 = {y}_{Q ( 90 )}$$

Where y_{Q(90)} is 90^{th} Percentile of y.

FIG. 9 is an exemplary graph illustrating an impact model for sell-by-date direction of threshold. In this case, the x and y is defined as earlier with a different form of mathematical model calculated as follows:

$$a - b * 0 = 0.$$

$$a + b * 1 = {y}_{Q ( 90 )}$$

Where y_{Q(90)} is 90^{th} Percentile of y.

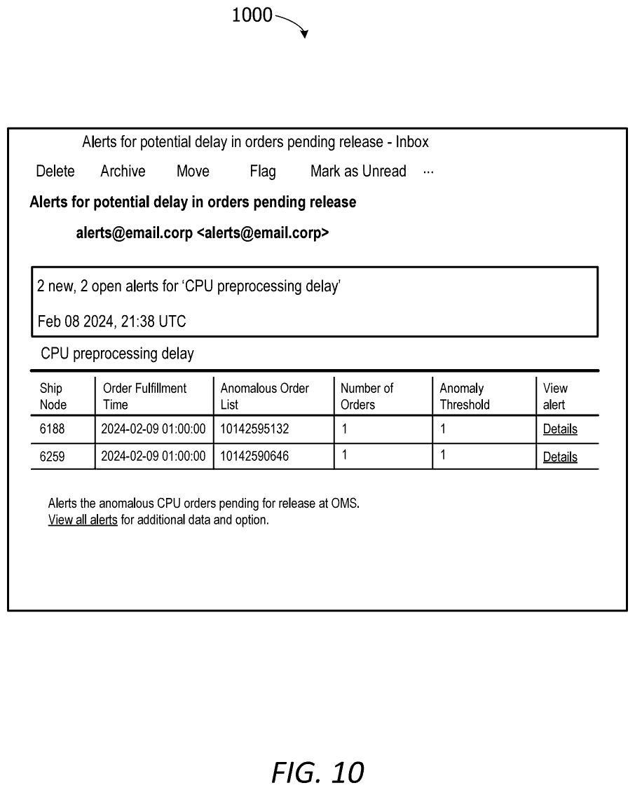

FIG. 10 is an exemplary diagram illustrating an email alert 1000 associated with an anomalous batch of perishable items. An email alert 1000 is optionally transmitted to one or more recipients for viewing via a UI, such as, but not limited to, the user interface device 110 and/or the UI device 120 in FIG. 1.

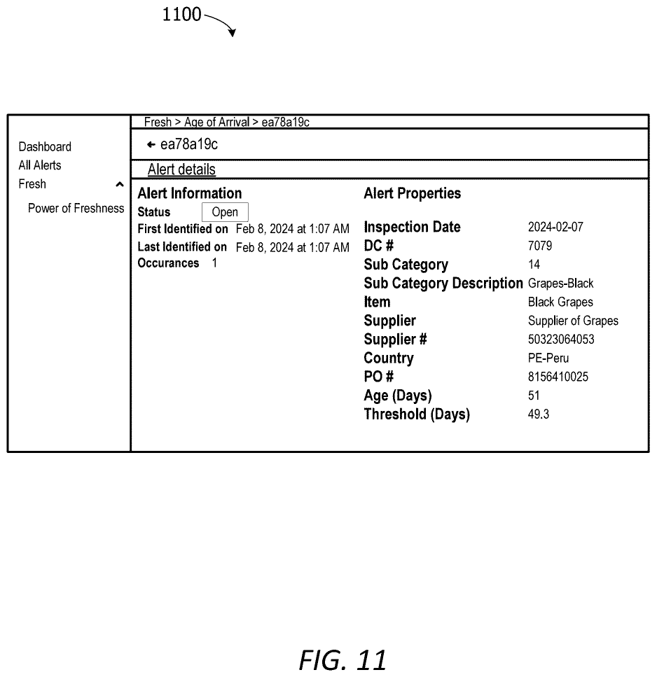

FIG. 11 is an exemplary diagram illustrating an alerts dashboard 1100 showing alert-related data for a plurality of alerts associated with a plurality of perishable item orders. These alerts are provided to reduce throws, pulls, and other waste at both the DC and store levels, as well as prevent failures in timely order delivery due to replenishment problems associated with unexpected Item-outs associated with perishable Items. In some embodiments, the system generates hourly alerts on anomalous number of orders stuck at different statuses and different systems for multiple stores and/or multiple DCs.

### ADDITIONAL EXAMPLES

In some embodiments, the system enables estimation/prediction of wastage for perishable goods received at a DC. The system estimates the goods that are to be sent to stores based on a shelf life of each perishable item or current age on arrival of the item when it is received at the DC. The system implements a predictive ML model to predict the wastage for a given item/batch of items based on item-specific data, supplier data, item in transit, etc. The system uses the prediction to determine whether to reject the shipment, return the items to the supplier, prioritize shipment of the items to stores for quick sale to customers, or other action to mitigate/reduce wastage. The system uses machine learning to predict wastage based on the shelf life and/or current age of the item on arrival. The system further utilizes other information such as seasonality, number of days at the days at the DC, number of days in transit to the DC, estimated number of days in transit to the destination store, and other data are used to predict the wastage for a particular item or batch of items in a shipment.

The system, in other embodiments, estimates store throws, returns, and complaints per million units for all anomalous purchase orders during inspection at the DC. The system estimates the impact these anomalous POs would have in terms of future DC/store wastages and defective returns from all customers at different stores. The system estimates number of days prior to wastage (item throws) estimated days remaining to sell the item without impacting quality of the item. The system estimates the throw for all items in a shipment (total units of a particular item/type of item). The system sent alerts to relevant DC teams after inspections to enable them to take action to avert wastages in future (Alerts are sent two times per day or at any user-configurable interval).

In other embodiments, the system utilizes an ML based dynamic threshold-based anomaly detection model on age on arrival and remaining shelf life of all fresh produces at all DCs right after the inspections by the QC team at DCs. The system generates alerts on all anomalous POs and surfaces it to all relevant teams to take pro-active actions. The model consists of hyperparameters which are changed to get strict or lenient alerts depending on business feedback, criticality of alerts and nature of fresh produces.

In some embodiments, the system performs aanomaly detection using age on arrival and remaining shelf life for alert generation. An ML driven dynamic threshold-based anomaly detection model analyses age on arrival and remaining shelf life of all fresh produces at all DCs right after the inspections happen by quality control at DCs. Alerts are generated for anomalous perishable item orders. The alerts are surfaced to all relevant teams to take pro-active actions. The system also estimates the impact these anomalous perishable items would have in terms of future DC and store wastages and defective returns from all customers at different stores. The system enables identification of anomalous batches of items following inspection, saving substantially on inventory charges, handling fees, logistics costs etc. Additionally, customer complaints are decreased by a significant margin. This further helps prioritization of shipments to stores, negotiations with suppliers, reducing nil picks, and reducing overall wastages via providing potential wastage inputs to replenishment.

In some embodiments, granularity of the alerts is customizable. A user can choose to receive alerts at a DC level, store level, or any other level. Alerts can also be provided at a user-configurable frequency. In one example, alerts are provided twice daily. However, the embodiments are not limited to two alerts per day. Alerts may be provided once a day, three or more times a day, every other day, or any other user-configurable frequency. The algorithm consists of hyperparameters which can be changed to get strict or lenient alerts depending on user feedback, criticality of alerts and nature of fresh produces.

In some embodiments, the system estimates store throws, returns, and complaints per million units for all anomalous Purchase Orders (POs) during inspections at the DC. Currently, POs from a DC are sent to various stores, each with varying residence times and transit times from the DC. All the anomalous PO alerts are being sent to relevant DC teams twice everyday just after inspections to enable them take pro-active actions to avert any potential wastages in future.

The system utilizes an ML model, in some embodiments, that is a Seasonal Hybrid Extreme Studentized Residual method here which is dynamic threshold based and takes all time series components into account. The system considers yearly, weekly and daily seasonality to detect anomalies and also include feedback from the stakeholders into the model. This solution also provides scalable system which can be utilized to estimate future throws at DC inspection time, providing enough time to change replenishment and prioritize POs to store. Impacted throws for every anomalous PO is based on the total accepted quantity and the delta age on arrival of the PO. The dependent variable y is defined as impacted throw quantity/accepted units and independent variable x as the age on arrival/threshold of a PO. For training the predictive model, the impacted store throws are derived as the linear combinations of previous days' accepted quantities at corresponding DCs. The exact weights for the linear combination taken to derive the impacted throws, were derived from another ML model taking lags of accepted quantities as x and total throws as y corresponding to a day.

Alternatively, or in addition to the other examples described herein, examples include any combination of the following:
calculate an estimated number of perishable item returns and complaints per million units (CPMU) for the anomalous batch of perishable items, wherein the estimated future impact includes the estimated number of perishable item returns and the calculated CPMU;
identify a destination having a shortage of items corresponding to one or more of the items in the anomalous batch of perishable items;
prioritize transport of the anomalous batch of perishable items from the DC to the identified destination, wherein the transport of the anomalous batch of perishable items is accelerated to increase a probability the perishable items in the anomalous batch of perishable items arrives at the identified destination with a number of days of remaining shelf life exceeding a threshold minimum number of days to ensure quality of the perishable items upon arrival at the destination;
calculate an estimated total number of units of a perishable item of a particular type of item having an age on arrival above a dynamic minimum threshold or an estimated remaining shelf life below a dynamic maximum threshold;
identify the estimated total number of units of the perishable item as the estimated quantity of throws due to wastage;
calculate an estimated wastage of the anomalous batch of perishable items at a DC level;
calculate an estimated wastage of the anomalous batch of perishable items at a store level;
generate an anomaly detection alert associated with a plurality of batches of perishable items associated with at least one anomaly detected at a user-configurable frequency;
obtaining item-specific data associated with a plurality of perishable items received at a distribution center (DC) and historical quality-related data associated with previous batches of perishable items received at the DC;
detecting, by a machine learning (ML) model, an anomalous batch of perishable items within the plurality of perishable items based on analysis of the item-specific data and the historical quality-related data, wherein the ML model is trained to detect anomalies in the item-specific data, including transit-time anomalies associated with transit delays;
calculating age-related data associated with the detected anomalous batch of perishable items, the age-related data comprising at least one of an estimated age of arrival (AoA) and an estimated remaining shelf life;
a calculated age of arrival and an estimated remaining shelf life can be used to estimate future impact, wherein the calculated age of arrival is generated based on shelf life, transit time, and other item-related data, the calculated age of arrival being more accurate than an estimated age of arrival;
estimating a future impact of the anomalous batch of perishable items using the calculated age-related data and an item-specific dynamic threshold, wherein the estimated future impact comprises an estimated quantity of throws due to wastage;
generating a recommendation to accept or reject the anomalous batch of perishable items based on the estimated future impact, the recommendation including a recommended action to mitigate perishable item wastage;
surfacing the generated recommendation via a user interface (UI) device;
calculating an estimated number of perishable item returns and complaints per million units (CPMU) for the anomalous batch of perishable items, wherein the estimated future impact includes the estimated number of perishable item returns and the calculated CPMU;
identifying a destination having a shortage of items corresponding to one or more of the items in the anomalous batch of perishable items;
prioritizing transport of the anomalous batch of perishable items from the DC to the identified destination, wherein the transport of the anomalous batch of perishable items is accelerated to increase a probability the perishable items in the anomalous batch of perishable items arrives at the identified destination with a number of days of remaining shelf life exceeding a threshold minimum number of days to ensure quality of the perishable items upon arrival at the destination;
calculating an estimated total number of units of a perishable item of a particular type of item having an age on arrival above a dynamic minimum threshold or an estimated remaining shelf life below a dynamic maximum threshold;
identifying the estimated total number of units of the perishable item as the estimated quantity of throws due to wastage;
calculating an estimated wastage of the anomalous batch of perishable items at a DC level and/or at a store level; and
generating an anomaly detection alert associated with a plurality of batches of perishable items associated with detected anomalies at a user-configurable frequency.

At least a portion of the functionality of the various elements in FIG. 1, FIG. 2, and FIG. 3 can be performed by other elements in FIG. 1, FIG. 2, and FIG. 3, or an entity (e.g., processor 106, web service, server, application program, computing device, etc.) not shown in FIG. 1, FIG. 2, and FIG. 3.

In some examples, the operations illustrated in FIG. 4 and FIG. 5 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

In other examples, a computer readable medium having instructions recorded thereon which when executed by a computer device cause the computer device to cooperate in performing a method of anomaly detection associated with perishable items, the method comprising obtaining item-specific data associated with a plurality of perishable items received at a distribution center (DC) and historical quality-related data associated with previous batches of perishable items received at the DC; detecting, by a machine learning (ML) model, an anomalous batch of perishable items within the plurality of perishable items based on analysis of the item-specific data and the historical quality-related data, wherein the ML model is trained to detect anomalies in the item-specific data, including transit-time anomalies associated with transit delays; calculating age-related data associated with the detected anomalous batch of perishable items, the age-related data comprising at least one of an estimated age of arrival (AoA) and an estimated remaining shelf life; estimating a future impact of the anomalous batch of perishable items using the calculated age-related data and an item-specific dynamic threshold, wherein the estimated future impact comprises an estimated quantity of throws due to wastage; generating a recommendation to accept or reject the anomalous batch of perishable items based on the estimated future impact, the recommendation including a recommended action to mitigate perishable item wastage; and surfacing the generated recommendation via a user interface (UI) device.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH®” as used herein refers, in some examples, to a wireless technology standard for exchanging data over short distances using short wavelength radio transmission. The term “NFC” as used herein refers, in some examples, to a short-range high frequency wireless communication technology for the exchange of data over short distances.

### Exemplary Operating Environment

Exemplary computer-readable media include flash memory drives, digital versatile discs (DVDs), compact discs (CDs), floppy disks, and tape cassettes. By way of example and not limitation, computer-readable media comprise computer storage media and communication media. Computer storage media include volatile and nonvolatile, removable, and non-removable media implemented in any method or technology for storage of information such as computer-readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer-readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other special purpose computing system environments, configurations, or devices.

Examples of well-known computing systems, environments, and/or configurations that can be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices can accept input from the user in any way, including from input devices such as a keyboard or pointing device, via gesture input, proximity input (such as by hovering), and/or via voice input.

Examples of the disclosure can be described in the general context of computer-executable instructions, such as program modules, executed by one or more computers or other devices in software, firmware, hardware, or a combination thereof. The computer-executable instructions can be organized into one or more computer-executable components or modules. Generally, program modules include, but are not limited to, routines, programs, objects, components, and data structures that perform tasks or implement abstract data types. Aspects of the disclosure can be implemented with any number and organization of such components or modules. For example, aspects of the disclosure are not limited to the specific computer-executable instructions, or the specific components or modules illustrated in the figures and described herein. Other examples of the disclosure can include different computer-executable instructions or components having more functionality or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for anomaly detection for reduced perishable item wastage. For example, the elements illustrated in FIG. 1, FIG. 2, and FIG. 3, such as when encoded to perform the operations illustrated in FIG. 4, and FIG. 5, constitute exemplary means for obtaining item-specific data associated with a plurality of perishable items received at a distribution center (DC) and historical quality-related data associated with previous batches of perishable items received at the DC; exemplary means for detecting, by a machine learning (ML) model, an anomalous batch of perishable items within the plurality of perishable items based on analysis of the item-specific data and the historical quality-related data, wherein the ML model is trained to detect anomalies in the item-specific data, including transit-time anomalies associated with transit delays; exemplary means for calculating age-related data associated with the detected anomalous batch of perishable items, the age-related data comprising at least one of an estimated age of arrival (AoA) and an estimated remaining shelf life; exemplary means for estimating a future impact of the anomalous batch of perishable items using the calculated age-related data and an item-specific dynamic threshold, wherein the estimated future impact comprises an estimated quantity of throws due to wastage; exemplary means for generating a recommendation to accept or reject the anomalous batch of perishable items based on the estimated future impact, the recommendation including a recommended action to mitigate perishable item wastage; and exemplary means for surfacing the generated recommendation via a user interface (UI) device.

Other non-limiting examples provide one or more computer storage devices having a first computer-executable instructions stored thereon for providing reduced perishable item wastage via anomaly detection. When executed by a computer, the computer performs operations including obtaining item-specific data associated with a plurality of perishable items received at a distribution center (DC) and historical quality-related data associated with previous batches of perishable items received at the DC; detecting, by a machine learning (ML) model, an anomalous batch of perishable items within the plurality of perishable items based on analysis of the item-specific data and the historical quality-related data, wherein the ML model is trained to detect anomalies in the item-specific data, including transit-time anomalies associated with transit delays; calculating age-related data associated with the detected anomalous batch of perishable items, the age-related data comprising at least one of an estimated age of arrival (AoA) and an estimated remaining shelf life; estimating a future impact of the anomalous batch of perishable items using the calculated age-related data and an item-specific dynamic threshold, wherein the estimated future impact comprises an estimated quantity of throws due to wastage; generating a recommendation to accept or reject the anomalous batch of perishable items based on the estimated future impact, the recommendation including a recommended action to mitigate perishable item wastage; and surfacing the generated recommendation via a user interface (UI) device.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing an operation before, contemporaneously with, or after another operation is within the scope of aspects of the disclosure.

The indefinite articles “a” and “an,” as used in the specification and in the claims, unless clearly indicated to the contrary, should be understood to mean “at least one.” The phrase “and/or” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to “A” only (optionally including elements other than “B”); in another embodiment, to B only (optionally including elements other than “A”); in yet another embodiment, to both “A” and “B” (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either” “one of” “only one of” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of ‘A’ and ‘B’” (or, equivalently, “at least one of ‘A’ or ‘B’,” or, equivalently “at least one of ‘A’ and/or ‘B’”) can refer, in one embodiment, to at least one, optionally including more than one, “A”, with no “B” present (and optionally including elements other than “B”); in another embodiment, to at least one, optionally including more than one, “B”, with no “A” present (and optionally including elements other than “A”); in yet another embodiment, to at least one, optionally including more than one, “A”, and at least one, optionally including more than one, “B” (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

1. A system for anomaly detection mitigating perishable item wastage, the system comprising:
a processor; and
a computer-readable medium storing programming instructions that, upon execution by the processor, cause the processor to:
train a machine learning model to detect anomalies for historical perishable items based on an amount of time the historical perishable items spent in transit to a distribution center (DC), age on arrivals (AoAs) of the historical perishable items at the time the historical perishable items were received at the DC, and estimated shelf lives of the historical perishable items at the time the perishable items were received at the DC;
obtain item-specific data associated with new perishable items received at the DC after the historical perishable items;
detect, by the trained ML model, an anomalous batch of perishable items within the perishable items based on the item-specific data;
calculate age-related data associated with the anomalous batch of perishable items, the age-related data comprising AOAs of the anomalous batch of perishable items and an estimated remaining shelf life of the anomalous batch of perishable items at the time the anomalous batch of perishable items was received at the DC;
estimate a future impact of the anomalous batch of perishable items using the calculated age-related data and an item-specific dynamic threshold, wherein the estimated future impact comprises an estimated quantity of throws due to wastage;
generate a recommendation to accept or reject the anomalous batch of perishable items based on the estimated future impact, the recommendation including a recommended action to mitigate perishable item wastage; and
surface the generated recommendation via a user interface (UI) device.

2. The system of claim 1, wherein the programming instructions further cause the processor to:
calculate an estimated number of perishable item returns and complaints per million units (CPMU) for the anomalous batch of perishable items, wherein the estimated future impact includes the estimated number of perishable item returns and the calculated CPMU.

3. The system of claim 1, wherein the programming instructions further cause the processor to:
identify a destination having a shortage of items corresponding to one or more of the items in the anomalous batch of perishable items; and
prioritize transport of the anomalous batch of perishable items from the DC to the identified destination, wherein the transport of the anomalous batch of perishable items is accelerated to increase a probability the perishable items in the anomalous batch of perishable items arrives at the identified destination with a number of days of remaining shelf life exceeding a threshold minimum number of days to ensure quality of the perishable items upon arrival at the destination.

4. The system of claim 1, wherein the programming instructions further cause the processor to:
calculate an estimated total number of units of a perishable item of a particular type of item having an age on arrival above a dynamic minimum threshold or an estimated remaining shelf life below a dynamic maximum threshold; and
identify the estimated total number of units of the perishable item as the estimated quantity of throws due to wastage.

5. The system of claim 1, wherein the programming instructions further cause the processor to:
calculate an estimated wastage of the anomalous batch of perishable items at a DC level.

6. The system of claim 1, wherein the programming instructions further cause the processor to:
calculate an estimated wastage of the anomalous batch of perishable items at a store level.

7. The system of claim 1, wherein the programming instructions further cause the processor to:
generate an anomaly detection alert associated with a plurality of batches of perishable items associated with at least one detected anomaly at a user-configurable frequency.

8. A method comprising:
training a machine learning model to detect anomalies for historical perishable items based on an amount of time the historical perishable items spent in transit to a distribution center (DC), age on arrivals (AoAs) of the historical perishable items at the time the historical perishable items were received at the DC, and estimated shelf lives of the historical perishable items at the time the perishable items were received at the DC;
obtaining item-specific data associated with new perishable items received at the DC after the historical perishable items;
detecting, by the trained ML model, an anomalous batch of perishable items within the perishable items based on the item-specific data;
calculating age-related data associated with the anomalous batch of perishable items, the age-related data comprising AOAs of the anomalous batch of perishable items and an estimated remaining shelf life of the anomalous batch of perishable items at the time the anomalous batch of perishable items was received at the DC;
estimating a future impact of the anomalous batch of perishable items using the calculated age-related data and an item-specific dynamic threshold, wherein the estimated future impact comprises an estimated quantity of throws due to wastage;
generating a recommendation to accept or reject the anomalous batch of perishable items based on the estimated future impact, the recommendation including a recommended action to mitigate perishable item wastage; and
surfacing the generated recommendation via a user interface (UI) device.

9. The method of claim 8, further comprising:
calculating an estimated number of perishable item returns and complaints per million units (CPMU) for the anomalous batch of perishable items, wherein the estimated future impact includes the estimated number of perishable item returns and the calculated CPMU.

10. The method of claim 8, further comprising:
identifying a destination having a shortage of items corresponding to one or more of the items in the anomalous batch of perishable items; and
prioritizing transport of the anomalous batch of perishable items from the DC to the identified destination, wherein the transport of the anomalous batch of perishable items is accelerated to increase a probability the perishable items in the anomalous batch of perishable items arrives at the identified destination with a number of days of remaining shelf life exceeding a threshold minimum number of days to ensure quality of the perishable items upon arrival at the destination.

11. The method of claim 8, further comprising:
calculating an estimated total number of units of a perishable item of a particular type of item having an age on arrival above a dynamic minimum threshold or an estimated remaining shelf life below a dynamic maximum threshold; and
identifying the estimated total number of units of the perishable item as the estimated quantity of throws due to wastage.

12. The method of claim 8, further comprising:
calculating an estimated wastage of the anomalous batch of perishable items at a DC level.

13. The method of claim 8, further comprising:
calculating an estimated wastage of the anomalous batch of perishable items at a store level.

14. The method of claim 8, further comprising:
generating an anomaly detection alert associated with a plurality of batches of perishable items associated with at least one anomaly detected at a user-configurable frequency.

15. One or more computer storage devices having programming instructions stored thereon, which, upon execution by a processor, cause the processor to:
train a machine learning model to detect anomalies for historical perishable items based on an amount of time the historical perishable items spent in transit to a distribution center (DC), age on arrivals (AoAs) of the historical perishable items at the time the historical perishable items were received at the DC, and estimated shelf lives of the historical perishable items at the time the perishable items were received at the DC;
obtain item-specific data associated with new perishable items received at the DC after the historical perishable items;
detect, by the trained ML model, an anomalous batch of perishable items within the plurality of perishable items based on the item-specific data;
calculate age-related data associated with the anomalous batch of perishable items, the age-related data comprising AOAs of the anomalous batch of perishable items and an estimated remaining shelf life of the anomalous batch of perishable items at the time the anomalous batch of perishable items was received at the DC;
estimate a future impact of the anomalous batch of perishable items using the calculated age-related data and an item-specific dynamic threshold, wherein the estimated future impact comprises an estimated quantity of throws due to wastage;
generate a recommendation to accept or reject the anomalous batch of perishable items based on the estimated future impact, the recommendation including a recommended action to mitigate perishable item wastage; and
surface the generated recommendation via a user interface (UI) device.

16. The one or more computer storage devices of claim 15, wherein the programming instructions further cause the processor to:
calculate an estimated number of perishable item returns and complaints per million units (CPMU) for the anomalous batch of perishable items, wherein the estimated future impact includes the estimated number of perishable item returns and the calculated CPMU.

17. The one or more computer storage devices of claim 15, wherein the programming instructions further cause the processor to:
identify a destination having a shortage of items corresponding to one or more of the items in the anomalous batch of perishable items; and
prioritize transport of the anomalous batch of perishable items from the DC to the identified destination, wherein the transport of the anomalous batch of perishable items is accelerated to increase a probability the perishable items in the anomalous batch of perishable items arrives at the identified destination with a number of days of remaining shelf life exceeding a threshold minimum number of days to ensure quality of the perishable items upon arrival at the destination.

18. The one or more computer storage devices of claim 15, wherein the programming instructions further cause the processor to:
calculate an estimated total number of units of a perishable item of a particular type of item having an age on arrival above a dynamic minimum threshold or an estimated remaining shelf life below a dynamic maximum threshold; and
identify the estimated total number of units of the perishable item as the estimated quantity of throws due to wastage.

19. The one or more computer storage devices of claim 15, wherein the programming instructions further cause the processor to:
calculate an estimated wastage of the anomalous batch of perishable items at a DC level and a store level.

20. The one or more computer storage devices of claim 15, wherein the programming instructions further cause the processor to:
generate an anomaly detection alert associated with a plurality of batches of perishable items associated with at least one anomaly detected at a user-configurable frequency.
